(19) United States
(12) Patent Application Publication
(10) Pub. No.: US 2010/0200328 A1
(43) Pub. Date: Aug. 12, 2010

(54) HYDRAULIC BOOM SYSTEM FOR VEHICLE

(75) Inventors: GILLES SAVARD, SAGUENAY (CA); NICOLAS GAUDREAULT, LA BAIE (CA); PIERRE GAGNON, LA BAIE (CA)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: CONCEPTION GSR INC., JONUIERE - QUEBEC (CA)

(21) Appl. No.: 12/366,878

(22) Filed: Feb. 6, 2009

(51) Int. Cl. E06C 5/06; E06C 5/10; E06C 5/32

(52) U.S. Cl. 182/2.1; 182/65.1; 182/66.2

(57) ABSTRACT

The hydraulic boom system can include a boom receiving a work platform; a fixed component fixedly mountable to the vehicle; a rotary component, rotatably mounted on the fixed component about a vertical axis; a pivotal component, pivotally mounted to the rotary component about a horizontal axis, and receiving the boom; a hydraulic power unit having an electric motor driven hydraulic pump; and an electrical cable connected to the electric motor, and connectable to an electrical power supply located at a fixed position relative to the vehicle. The hydraulic power unit can be made integral to the rotary component. A raising hydraulic cylinder can extend downwardly inside a spacing in the fixed component. The electrical cable can have a coiled portion housed in the fixed component and coiled around the vertical axis.

### FIELD

The specification generally relates to the field of hydraulic booms for vehicles, such as aerial ladders for instance, and more particularly discloses an articulation mechanism therefore.

### BACKGROUND

Hydraulic booms are used in a wide variety of applications and typically include a work platform, sometimes called a “bucket”, at a free end thereof, in which a worker can be raised and moved by movement of the boom, typically driven with hydraulic components. Hydraulic booms are typically articulated at the other end thereof which connects the vehicle, opposite the work platform, for pivoting about at least two axes. An example of a hydraulic boom is an aerial ladder, in which the boom is typically an extendible ladder leading to the work platform and in which the work platform can typically be swung laterally about a vertical axis intersecting the other end of the boom, and swung upwardly/downwardly about a horizontal axis.

Because hydraulic booms typically include at least one hydraulic actuating cylinder or motor, such as to raise/lower the boom, swing the boom laterally, extend the ladder, and maintain the level of the work platform as the boom is raised and lowered, they have used hydraulic power from a hydraulic power unit, which typically includes at least a hydraulic pump and a hydraulic fluid tank. It was known to provide the hydraulic pump and hydraulic fluid tank in a fixed location relative to the vehicle, and to use hydraulic hoses to interconnect the hydraulic pump and the hydraulic components. However, designing the hydraulic hose configuration in consideration with the freedom of movement of the boom was challenging, at least partially because of the limited flexibility of hydraulic hoses and their limited ability to endure successive flexing over time. Furthermore, the components required to allow pivoting of the boom about two independent axes typically resulted in relatively high thickness, which was less than ideal for the aerodynamics of the vehicle. Henceforth, although known hydraulic boom systems were satisfactory to a certain degree, there remained room for improvement.

### SUMMARY

The aforementioned limitation relating to wear-resistance of hydraulic hoses can be at least partially overcome in a system such as described herein where the hydraulic power unit is provided in a rotary component of the system, i.e. where it moves with the boom as the boom is swung laterally. If the hydraulic power unit is powered by an electric motor, an electrical cable, which typically has more flexibility and wear-resistance than a hydraulic hose, can be connected to the vehicle and thus be subject to the swinging movement of the boom instead of a hydraulic hose. A further improvement resides in the disclosed coiled configuration of the electrical cable in a fixed component of the system which contributes to minimize the stress to which the electrical cable is subjected to when the boom is swung laterally.

The afore mentioned limitation relating to overall height of the pivoting mechanism can be at least partially overcome with the system described herein by using a hydraulic cylinder to pivot the boom upwardly/downwardly about a horizontal axis which has a base connected to a lower pivot which is provided as part of a rotary component of the system, and which penetrates inside an spacing provided in rotating system of the rotary component.

In accordance with one aspect, there is provided a hydraulic boom system for use on a vehicle, the hydraulic boom system comprising: a boom having a first end receiving a work platform, and a second end, opposite the first end; a fixed component fixedly mountable to the vehicle; a rotary component, rotatably mounted on the fixed component about a vertical axis; a pivotal component, pivotally mounted to the rotary component about a horizontal axis, and receiving the second end of the boom; a hydraulic power unit having an electric motor driven hydraulic pump connected to a hydraulic fluid tank, the hydraulic power unit being made integral to at least one of the rotary component and the pivotal component, and thereby rotating when the rotary component rotates; and an electrical cable connected to the electric motor, and connectable to an electrical power supply located at a fixed position relative to the vehicle.

In accordance with another aspect, there is provided a hydraulic boom system for use on a vehicle, the hydraulic boom system comprising: a boom having a first end receiving a work platform, and a second end, opposite the first end; a fixed component fixedly mountable to the vehicle; a rotary component, rotatably mounted on the fixed component about a vertical axis; a spacing penetrating downwardly at least partially through the fixed component, around the vertical axis; a pivotal component, pivotally mounted to the rotary component about a horizontal axis, and receiving the second end of the boom; a raising hydraulic cylinder between the pivotal component and the rotary component to raise and lower the boom by pivoting the boom about the horizontal axis, the raising hydraulic cylinder having a first end connected to an upper pivot made integral to the pivotal component, between the horizontal pivot axis and the work platform, and a second end connected to a lower pivot which is made part integral to the rotary component, the second end extending downwardly inside the spacing.

In accordance with another aspect, there is provided a hydraulic boom system for use on a vehicle, the hydraulic boom system comprising: a boom having a first end receiving a work platform, and a second end, opposite the first end; a fixed component fixedly mountable to the vehicle; a rotary component, rotatably mounted on the fixed component about a vertical axis; a pivotal component, pivotally mounted to the rotary component about a horizontal axis, and receiving the second end of the boom; a hydraulic power unit having a hydraulic fluid tank and an electric motor driven hydraulic pump connected to the hydraulic fluid tank; and an electrical cable having a coiled portion housed in the fixed component and coiled around the vertical axis, extending upwardly from the coiled portion and connecting the electrical motor at a first end thereof, and having a second end opposite the coiled portion connectable to an electrical power supply located at a fixed position relative to the vehicle.

For the sake of clarity and simplicity, the expression “fixed” as used herein will be used to describe a fixed location or position relative to the vehicle, in contradistinction with the boom which moves relative to the vehicle. Also, the expressions horizontal and vertical are used for simplicity as relative to when the vehicle is resting on a horizontal surface.

### DESCRIPTION OF THE FIGURES

FIG. 1 is a perspective view of an example of a hydraulic boom system mounted on a vehicle;

FIG. 2 is an exploded perspective view showing a portion of the hydraulic boom system of FIG. 1;

FIG. 3 is another exploded perspective view showing some of the components of the hydraulic boom system in greater detail;

FIG. 4 is a perspective view showing a portion of the hydraulic power unit of the hydraulic boom system of FIG. 1; and

FIGS. 5A and 5B are perspective views showing some components of the hydraulic boom system in further detail.

### DETAILED DESCRIPTION

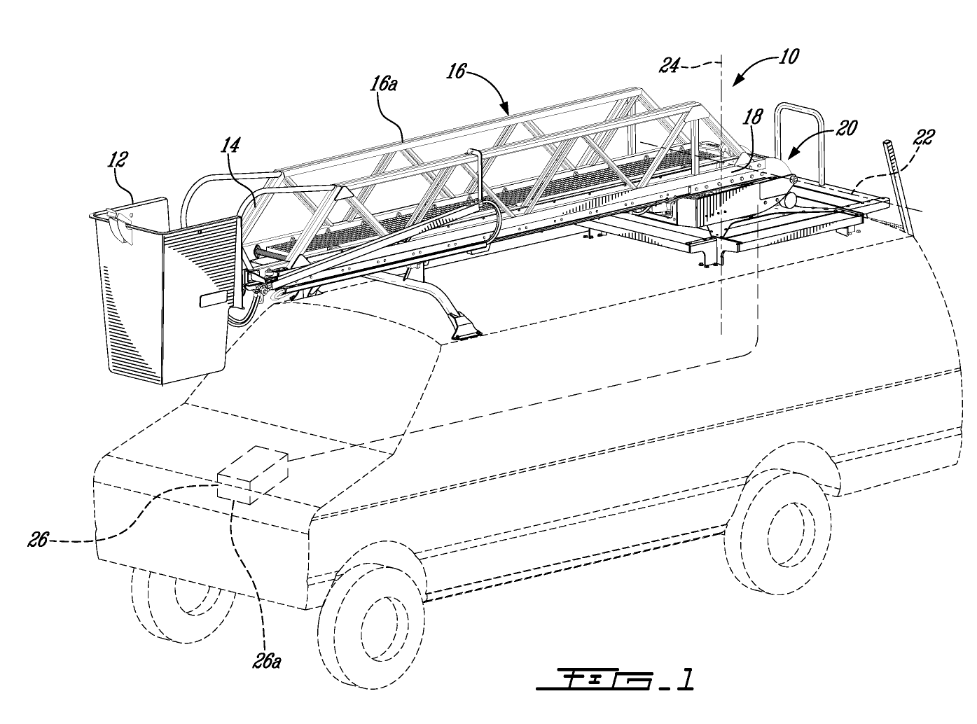

FIG. 1 shows an example of a hydraulic boom system 10. The hydraulic boom system 10 can be seen to generally include a work platform 12 mounted onto a first end 14 of a boom 16. A second end 18 of the boom 16 is received in a swinging mechanism 20 which allows to both raise and lower the work platform 12 by pivoting the boom 16 about a horizontal and transversal pivot axis 22 and to swing the boom 16 laterally by pivoting about a vertical pivot axis 24. The details of the pivoting mechanism 20 are provided further below.

In FIG. 1, the hydraulic boom system 10 is shown mounted on a vehicle, and the boom is shown in a fully centered and fully lowered position. The boom pivoting mechanism 20 is powered by an electrical power supply 26 which is in a fixed position relative to the vehicle. In this example, the electrical power supply 26 is a battery 26a of the vehicle, however in alternate embodiments, the electrical power supply can be a battery of a generator provided on or proximate the vehicle, or a battery connected in parallel with the battery of the vehicle, for instance. In this example, the boom 16 is an aerial ladder 16a, which is extendible as described further below.

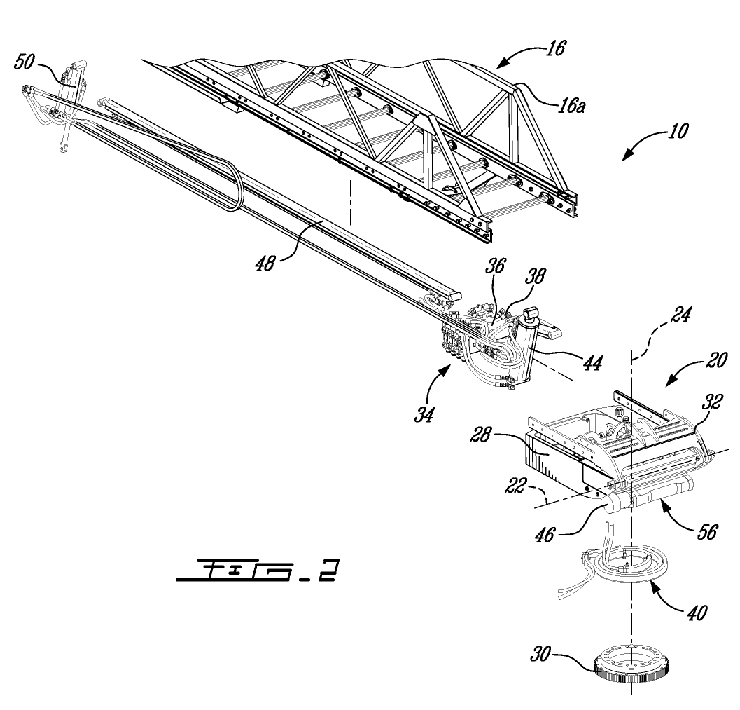

Turning to FIG. 2, some of the components of the hydraulic boom system 10 are shown in better detail. In particular, the boom pivoting mechanism 20 is shown more clearly. The boom pivoting mechanism 20 includes a rotary component 28, which is rotatably mounted to a fixed component 30, the latter being fixedly mounted to the vehicle. The rotary component 28, when it is rotated about the vertical axis 24, pivots the boom laterally. A pivotal component 32 is pivotally mounted to the rotary component 28 for pivoting about the horizontal axis 22. In this example, the vertical axis 24 and the horizontal axis 22 do not intersect. The pivoting of the pivotal component 32 about the horizontal axis 22 pivots the boom 16 in a raising and lowering movement.

The boom pivoting mechanism 20 includes a hydraulic power unit 34 which, in the illustrated embodiment, is provided as part of the rotary component 28, as will be detailed further below. The hydraulic power unit 34 has a hydraulic pump 36 which is powered by an electric motor 38. The electric motor 38 is connected to an electric cable 40, which leads to the electrical power supply 26 which is in a fixed position relative to the vehicle 42 (see FIG. 1). The hydraulic power unit 34 is used to power a raising hydraulic cylinder 44 which is mounted between the rotary component 28 and the pivotal component 32 and which is used to pivot the pivotal component 32 and the boom 16 around the horizontal pivot axis 22. The hydraulic power unit 34 also drives a motor 46 which actuates the rotation of the rotary component 28 about the vertical axis 24. Further, the hydraulic power unit 34 is used to power a ladder extension cylinder 48 for extending the aerial ladder 16a, and a work platform leveling cylinder 50 which is used to maintain the work platform leveled as the boom 16 is raised or lowered.

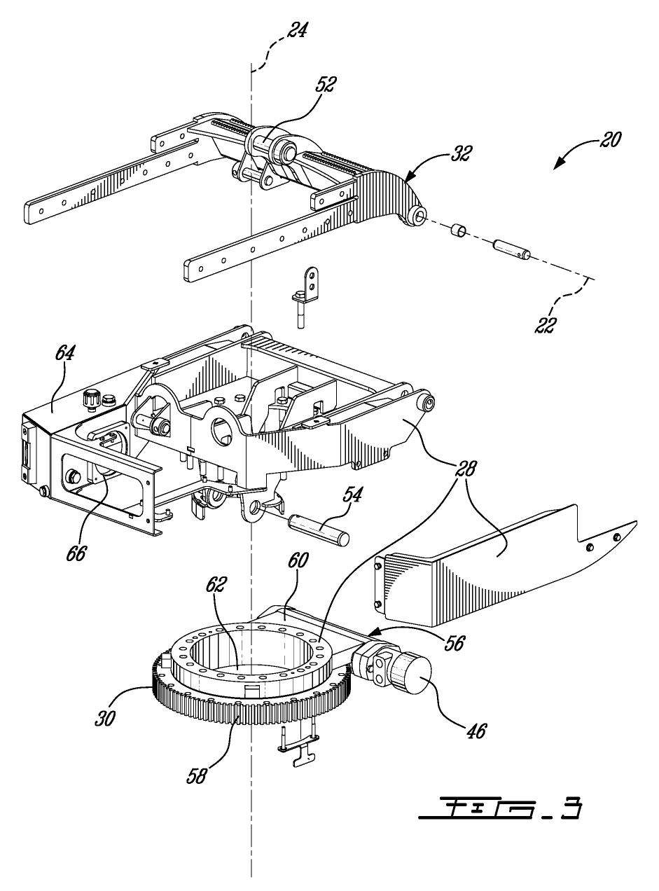

Turning to FIG. 3, some of the components of the boom pivoting mechanism 20 are shown in further detail. More particularly, the raising hydraulic cylinder 44 (FIG. 2), which is used for raising and lowering of the boom 16, is mountable for extension between an upper pivot 52 provided in the pivotal component 32, and a lower pivot 54 provided in the rotary component 28. When the boom 16 is in the lowered position shown in FIG. 1, the raising hydraulic cylinder 44 extends highly vertically between the upper pivot 52 and the lower pivot 54. In this specification, the expression highly vertically is used to refer to more than about 60° with reference to a horizontal plane, and preferably more than 70°.

As can be seen in FIG. 3, the rotation of the rotary component 28 with the pivotal component 32 around the vertical axis 24 is actuated by a worm drive 56. The worm drive 56 includes a worm gear 58, which in this case is generally annular and disposed horizontally, and a worm 60 (not visible), which is driven by the motor 46, and which is meshed with the worm gear 58, and actuates the rotation about the vertical axis 24 when activated. In this embodiment, the worm 60 and motor 46 are provided as part as the rotary component 28, whereas the worm gear 58 is provided as part of the fixed component 30, although the contrary is also possible in alternate embodiments. The motor 46 in this embodiment is hydraulic for convenience, though alternate motors can be used.

A central spacing 62 is provided around the vertical axis 24 in the center of the annular shape of the worm gear 58, and the lower pivot 54 of the raising cylinder 44 (FIG. 2) extends downwardly inside the spacing 62. This contributes to allow the raising hydraulic cylinder 44 to adopt the highly vertical orientation when the boom 16 is in the fully lowered position, and also contributes to reduce the overall height, or thickness, of the boom pivoting mechanism 20.

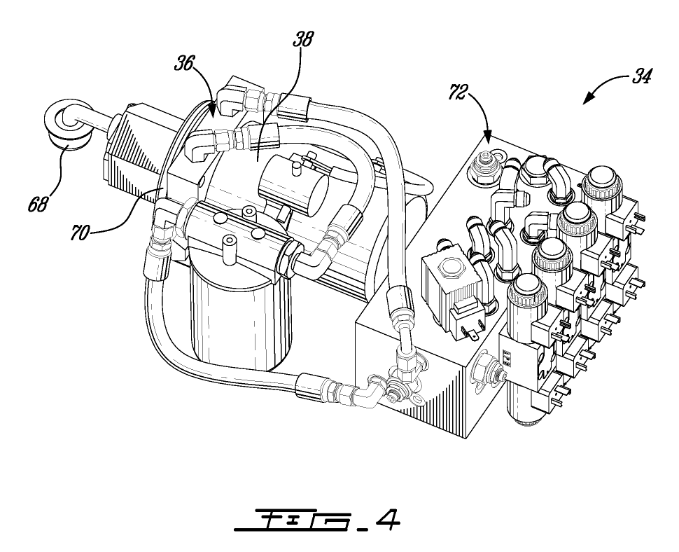

In this embodiment, the rotary component 28 also has a hydraulic fluid tank 64, which has a hydraulic pump port 66 configured to receive a hydraulic fluid inlet 68 of the hydraulic pump 36. The hydraulic pump 36 is shown in further detail in FIG. 4. In this example, the hydraulic pump 36 is driven by an electric motor 38 and has a port 70 which is adapted to mate with the hydraulic pump port 66 of the hydraulic fluid tank 64. The hydraulic pump 36 has a hydraulic fluid inlet 68 through which hydraulic fluid can be pumped from the hydraulic fluid tank 64 (FIG. 3). The hydraulic pump 36 is connected to a distribution unit 72 which feeds hydraulic fluid to different hydraulic cylinders 44, 48 of the system 10 and to the hydraulic motor 46 of the worm drive 56 (see FIG. 2).

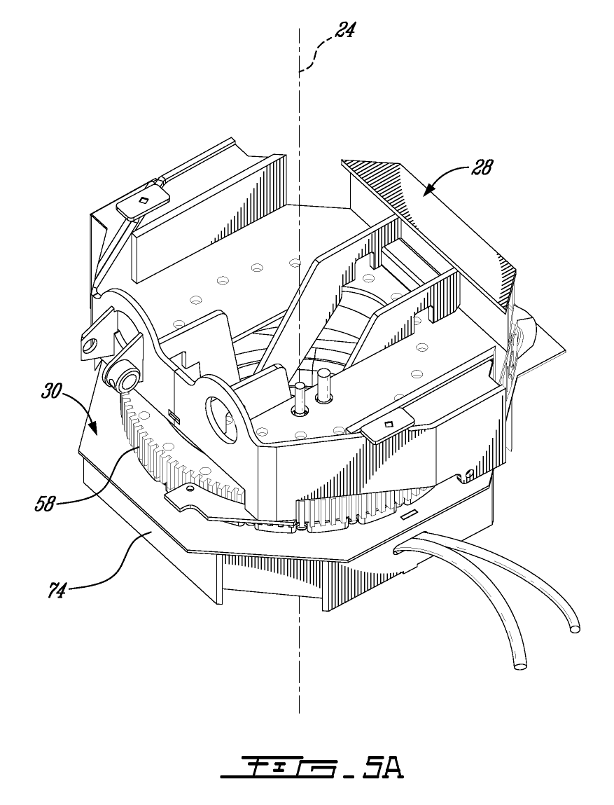

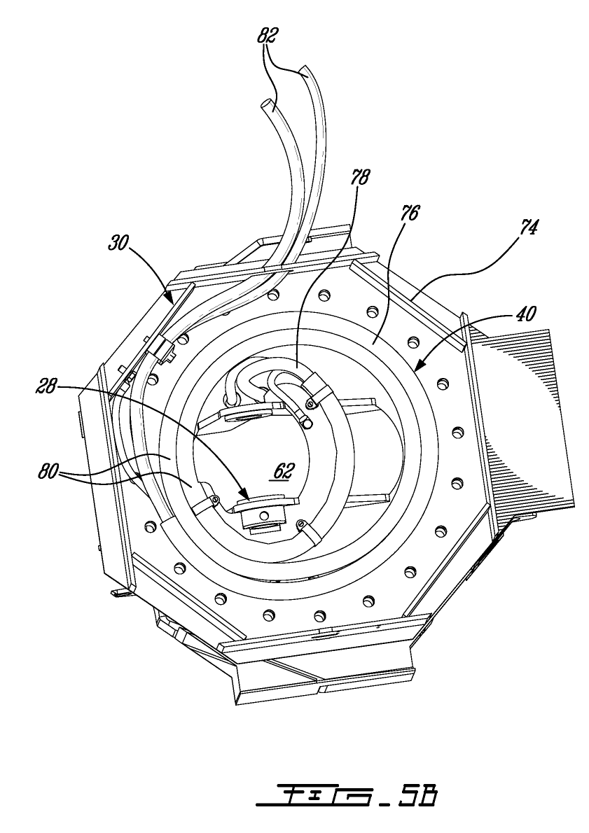

Turning now to FIGS. 5A and 5B, it can be seen that the worm gear 58 is fixedly mounted to a base 74, both of which are part of the fixed component 30. More specifically, in FIG. 5B, an electrical cable 40 has a coiled portion 76 which is housed inside the base 74. The coiled portion 76 is coiled around the vertical axis 24 and a portion 78 of the electrical cable 40 extends upwardly from the coiled portion 76 to the electric motor 38 of the hydraulic pump 36 (FIG. 4). This specific configuration of the coiled portion 76 results in the effect that when the rotary component 28 is rotated about the vertical axis 24 relative to the fixed component 30, coils 80 of the coiled portion 76 simply contract or extend, mostly radially relative to the vertical axis 24, inside the base 74. This results in a very limited amount of stress being imparted to the electrical cable 40. The other end 82 of the electrical cable 40 extends out through the base 74 and leads to the electrical power supply 26 (FIG. 1).

It will appear to person skilled in the art that many variants and alternate embodiments are possible upon considering the teachings of this specification, and that the illustrated embodiment is provided for indicative purposes only. The scope is indicated by the appended claims.

What is claimed is:

1. A hydraulic boom system for use on a vehicle, the hydraulic boom system comprising:
a boom having a first end receiving a work platform, and a second end, opposite the first end;
a fixed component fixedly mountable to the vehicle;
a rotary component, rotatably mounted on the fixed component about a vertical axis;
a pivotal component, pivotally mounted to the rotary component about a horizontal axis, and receiving the second end of the boom;
a hydraulic power unit having an electric motor driven hydraulic pump connected to a hydraulic fluid tank, the hydraulic power unit being made integral to at least one of the rotary component and the pivotal component, and thereby rotating when the rotary component rotates; and
an electrical cable connected to the electric motor, and connectable to an electrical power supply located at a fixed position relative to the vehicle.

2. The hydraulic boom system of claim 1 wherein the rotary component is rotatably mounted to the fixed component with a worm drive including motor-driven worm meshed onto a horizontally-oriented worm gear.

3. The hydraulic boom system of claim 2 wherein the worm-driving motor is a hydraulic motor powered by the hydraulic power unit.

4. The hydraulic boom system of claim 2 wherein the worm is made integral to the rotary component whereas the worm gear is made integral to the fixed component.

5. The hydraulic boom system of claim 2 wherein the worm gear is shaped as an annulus and a spacing is provided inside the annulus.

6. The hydraulic boom system of claim 5 wherein a raising hydraulic cylinder powered by the hydraulic power unit is provided between the pivotal component and the rotary component to raise and lower the boom by pivoting about the horizontal axis, the raising hydraulic cylinder having a first end connected to an upper pivot made part of the pivotal component, between the horizontal pivot axis and the work platform, and a second end connected to a lower pivot, made part of the rotary component, and extending in the spacing provided inside the annulus of the worm gear.

7. The hydraulic boom system of claim 6 wherein the raising hydraulic cylinder extends upwardly in a highly vertical manner when the boom is in a lowered position.

8. The hydraulic boom system of claim 5 wherein the electrical cable has a coiled portion provided in the fixed component, coiled around the vertical axis, and extends upwardly from the coiled portion through the spacing provided inside the annulus of the worm gear.

9. The hydraulic boom system of claim 1 wherein the electrical cable has a coiled portion provided in the fixed component and coiled around the vertical axis and extends upwardly from the coiled portion to the electrical motor.

10. The hydraulic boom system of claim 1 wherein the electrical power supply is a battery.

11. The hydraulic boom system of claim 1 wherein the hydraulic power unit is entirely made integral to the rotary component.

12. The hydraulic boom system of claim 1 wherein the boom is an extendible aerial ladder activatable via a corresponding extending hydraulic cylinder which is powered by the hydraulic power unit.

13. The hydraulic boom system of claim 1 further comprising a work platform leveling cylinder.

14. A hydraulic boom system for use on a vehicle, the hydraulic boom system comprising:
a boom having a first end receiving a work platform, and a second end, opposite the first end;
a fixed component fixedly mountable to the vehicle;
a rotary component, rotatably mounted on the fixed component about a vertical axis;
a spacing penetrating downwardly at least partially through the fixed component, around the vertical axis;
a pivotal component, pivotally mounted to the rotary component about a horizontal axis, and receiving the second end of the boom;
a raising hydraulic cylinder between the pivotal component and the rotary component to raise and lower the boom by pivoting the boom about the horizontal axis, the raising hydraulic cylinder having a first end connected to an upper pivot made integral to the pivotal component, between the horizontal pivot axis and the work platform, and a second end connected to a lower pivot which is made part integral to the rotary component, the second end extending downwardly inside the spacing.

15. The hydraulic boom system of claim 14 wherein the raising hydraulic cylinder extends upwardly in a highly vertical manner when the boom is in a lowered position.

16. The hydraulic boom system of claim 14 wherein the rotary component is rotatably mounted to the fixed component with a worm drive including a motor-driven worm meshed onto a horizontally-oriented worm gear.

17. The hydraulic boom system of claim 16 wherein the worm gear is shaped as an annulus and has the spacing provided inside the annulus.

18. The hydraulic boom system of claim 14 further comprising a hydraulic power unit having an electric motor driven hydraulic pump connected to a hydraulic fluid tank, the hydraulic power unit being associated with at least one of the rotary component and the pivotal component, and thereby rotating when the rotary component rotates; and an electrical cable connected to the electric motor, and connectable to an electrical power supply located at a fixed position relative to the vehicle.

19. The hydraulic boom system of claim 18 wherein the electrical cable has a coiled portion coiled around the vertical axis, and extends upwardly from the coiled portion to the electric motor.

20. The hydraulic boom system of claim 14 wherein the electrical power supply is a battery of the vehicle.

21. A hydraulic boom system for use on a vehicle, the hydraulic boom system comprising:
a boom having a first end receiving a work platform, and a second end, opposite the first end;
a fixed component fixedly mountable to the vehicle;
a rotary component, rotatably mounted on the fixed component about a vertical axis;
a pivotal component, pivotally mounted to the rotary component about a horizontal axis, and receiving the second end of the boom;
a hydraulic power unit having a hydraulic fluid tank and an electric motor driven hydraulic pump connected to the hydraulic fluid tank; and
an electrical cable having a coiled portion housed in the fixed component and coiled around the vertical axis, extending upwardly from the coiled portion and connecting the electrical motor at a first end thereof, and having a second end opposite the coiled portion connectable to an electrical power supply located at a fixed position relative to the vehicle.
